(19) United States
(12) Patent Application Publication
(10) Pub. No.: US 2022/0306871 A1
(43) Pub. Date: Sep. 29, 2022

(54) CONDUCTIVE PARTICLE, METHOD OF PREPARING THE SAME, AND DISPLAY PANEL

(71) Applicants: HKC CORPORATION LIMITED, Shenzhen (CN); CHONGQING HIKC OPTOELECTRONICS TECHNOLOGY CO., LTD., Chongqing (CN)

(72) Inventor: Xiaowu SUN, Chongqing (CN)

(21) Appl. No.: 17/617,946

(22) PCT Filed: Jun. 1, 2020
(86) PCT No.: PCT/CN2020/093690

§ 371 Date: Dec. 10, 2021

(30) Foreign Application Priority Data
Jun. 11, 2019 (CN) 201910500066.X

(51) Int. Cl. C09D 5/24; H01B 1/12; G02F 1/1339; C09D 7/40; C09D 7/65

(52) U.S. Cl. CPC C09D 5/24; H01B 1/128; G02F 1/1339; C09D 7/70; C09D 7/65

(57) ABSTRACT

A conductive particle and a method of preparing the same, and a display panel are disclosed. The conductive particle includes a core and a conductive layer covering the core. The material of the core is polystyrene, and the material of the conductive layer is polyaniline.

### CROSS-REFERENCE TO RELATED APPLICATIONS

This application is a United States national stage application of co-pending International Patent Application Number PCT/CN2020/093690, filed Jun. 1, 2020, which claims the priority to and benefit of Chinese patent application CN201910500066.X, entitled “Conductive Particle, Method of Preparing the Same, and Display Panel” and filed Jun. 11, 2019 with China National Intellectual Property Administration, the entire contents of which are incorporated herein by reference.

### TECHNICAL FIELD

This application relates to the field of display technology, and more particularly relates to a conductive particle, a method of preparing the same, and a display panel.

### BACKGROUND

The statements herein are intended for the mere purposes of providing background information related to the present application but don't necessarily constitute prior art.

Thin Film Transistor Liquid Crystal Displays (TFT-LCD) have gradually occupied the leading position in the display field by virtue of their low power consumption, excellent picture quality, and high production yield. Most of the liquid crystal displays on the market are backlight type liquid crystal display devices, which include a liquid crystal display panel and a backlight module. A liquid crystal display panel is typically composed of a color filter (CF) substrate, an array substrate, a liquid crystal sandwiched between the color filter substrate and the array substrate, and a sealant. In order to drive the liquid crystals between the two substrates to rotate, the current TFT-LCDs mainly connect the array substrate and the CF substrate through conductive gold balls to form a conductive path.

However, the cost of the conductive gold balls is relatively high, which increases the manufacturing cost of the display panel. In addition, the conductive gold balls are likely to squeeze the wires causing a short circuit.

### SUMMARY

It is therefore an objective of the present application to provide a conductive particle, a method of preparing the same, and a display panel, so as to reduce the cost of the display panel and reduce the impact on the circuit wires.

The present application discloses a conductive particle including a core and a conductive layer covering the core, where the material of the core is polystyrene, and the material of the conductive layer is polyaniline.

This application further discloses a method for preparing a conductive particle, the method including:

preparing a core made of polystyrene material; and

forming a conductive layer that covers the outside of core and that is made of polyaniline mated al.

This application further discloses a display panel, which includes a first substrate, a second substrate disposed opposite to the first substrate, and the above-mentioned conductive particles filled between the first substrate and the second substrate, where the first substrate is electrically connected to the second substrate through the conductive particles.

Contrasting the solution where the conductive particles are ordinary conductive gold balls, this application uses a two-layer structured conductive particle, that is, a core made of polystyrene and a conductive layer made of polyaniline. The particle size of the polystyrene core is controllable and the elasticity of the polystyrene core is also adjustable, so that the above parameters can be adjusted depending on different cell gaps to meet various needs. As such, when the core touches the circuit wires, it will change its shape, so it will not squeeze the circuit wires and cause a short circuit. The polyaniline conductive layer has low cost, low density and good conductive effect. Therefore, the conductive particle of the present application combines the advantages of the two materials, so that the conductive particle has low cost and will not adversely affect the circuit wires.

### BRIEF DESCRIPTION OF DRAWINGS

The accompanying drawings are used to provide a further understanding of the embodiments according to the present application, and constitute a part of the specification. They are used to illustrate the embodiments according to the present application, and explain the principle of the present application in conjunction with the text description. Apparently, the drawings in the following description merely represent some embodiments of the present disclosure, and for those having ordinary skill in the art, other drawings may also be obtained based on these drawings without investing creative efforts. A brief description of the accompanying drawings is provided as follows.

FIG. 1 shows a schematic diagram of a display panel according to an embodiment of the present application.

FIG. 2 shows a schematic diagram of a gold ball observed with a scanning electron microscope.

FIG. 3 shows a schematic diagram of a polystyrene core observed with a scanning electron microscope according to an embodiment of the application.

FIG. 4 shows a schematic diagram of a polystyrene core combined with a polyaniline conductive layer observed with a scanning electron microscope according to an embodiment of the application.

FIG. 5 shows a schematic diagram of a conductive particle according to an embodiment of the present application.

FIG. 6 shows a schematic diagram of another conductive particle according to an embodiment of the present application.

FIG. 7 shows a flowchart of a method for manufacturing a conductive particle according to an embodiment of the present application.

FIG. 8 shows a schematic diagram of a manufacturing process of a conductive particle according to an embodiment of the present application.

FIG. 9 shows a flowchart of a method for preparing a conductive particle according to another embodiment of the present application.

FIG. 10 shows a flowchart of a method for preparing a conductive particle according to another embodiment of the present application.

### DETAILED DESCRIPTION OF EMBODIMENTS

It should be understood that the terms used herein, the specific structures and function details disclosed herein are intended for the mere purposes of describing specific embodiments and are representative. However, this application may be implemented in many alternative forms and should not be construed as being limited to the embodiments set forth herein.

As used herein, terms “first”, “second”, or the like are merely used for illustrative purposes, and shall not be construed as indicating relative importance or implicitly indicating the number of technical features specified. Thus, unless otherwise specified, the features defined by “first” and “second” may explicitly or implicitly include one or more of such features. Terms “multiple”, “a plurality of”, and the like mean two or more. Term “comprising”, “including”, and any variants thereof mean non-exclusive inclusion, so that one or more other features, integers, steps, operations, units, components, and/or combinations thereof may be present or added.

In addition, terms “center”, “transverse”, “up”, “down”, “left”, “right”, “vertical”, “horizontal”, “top”, “bottom”, “inside”, “outside”, or the like are used to indicate orientational or relative positional relationships based on those illustrated in the drawings. They are merely intended for simplifying the description of the present disclosure, rather than indicating or implying that the device or element referred to must have a particular orientation or be constructed and operate in a particular orientation. Therefore, these terms are not to be construed as restricting the present disclosure.

Furthermore, as used herein, terms “installed on”, “mounted on”, “connected to”, “coupled to”, “connected with”, and “coupled with” should be understood in a broad sense unless otherwise specified and defined. For example, they may indicate a fixed connection, a detachable connection, or an integral connection. They may denote a mechanical connection, or an electrical connection. They may denote a direct connection, a connection through an intermediate, or an internal connection between two elements. For those of ordinary skill in the art, the specific meanings of the above terms as used in the present application can be understood depending on specific contexts.

Hereinafter this application will be described in further detail with reference to the accompanying drawings and some optional embodiments.

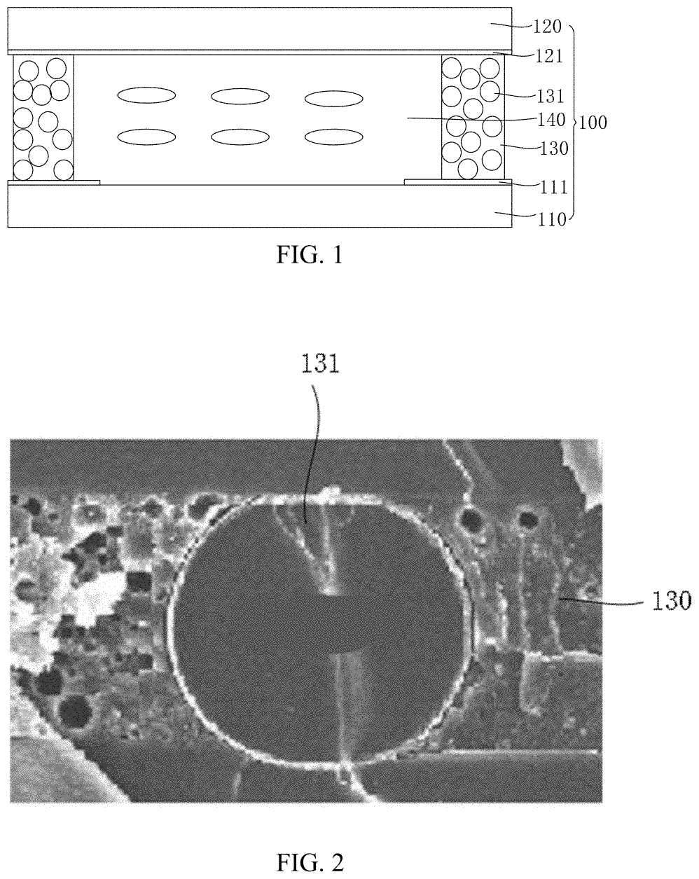

As illustrated in FIG. 1, the present application discloses a display panel 100, which includes: a first substrate 110, namely an array substrate; a second substrate 120 disposed opposite to the first substrate 110, namely a color film substrate; a liquid crystal layer 140 disposed between the color film substrate and the array substrate; a sealant 130 disposed on the edge of the color film substrate and the array substrate to seal the liquid crystal layer 140; and a conductive particle 131 disposed between the first substrate 110 and the second substrate 120, where the first substrate 110 is electrically connected to the second substrate 120 through the conductive particle 131. The conductive particles 131 may be disposed in the sealant 130 or outside the sealant 130. A common electrode 121 (C-Common) is disposed on the color film substrate, and a common line 111 (A-Common) is disposed on the array substrate. In order to drive the liquid crystals between the two substrates to rotate, conductive particles 131 are required to connect the common line 111 on the array substrate with the common electrode 121 on the color filter substrate to form a conductive path.

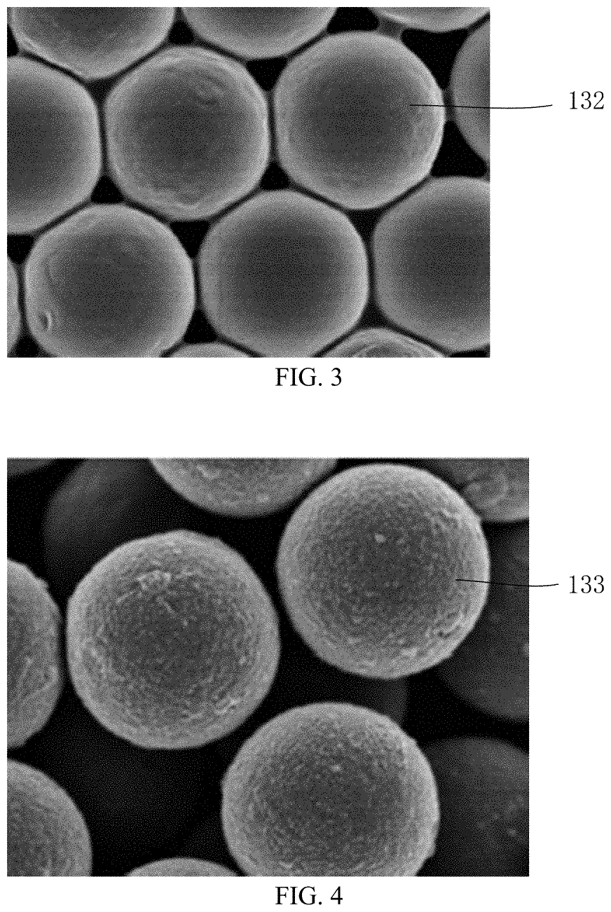

The inventor learned that the conductive particles 131 are mostly conductive gold balls. The inner layer of the gold ball is a spherical and elastic polymer material with a uniform particle size. The outside is covered with an outer layer of nickel (Ni), and then a layer of gold (Au) is plated on the Ni surface by electroless plating, or a silver (Ag) layer is used here instead of the Ni layer and the Au layer to create the conductive particle 131. The above-mentioned Ni/Au (or Ag)-coated conductive gold balls have the following problems: 1) The process is complicated; 2) Gold is a precious metal, which is expensive; 3) The gold salt used in the gold plating process is mostly cyanide, which is very toxic; 4) The gold ball is easy to crush the circuit wires causing a short circuit; 5) The adhesion with the sealant 130 is poor. As illustrated in FIG. 2, which shows a schematic diagram of a conductive gold ball observed under a scanning electron microscope (SEM). Therefore, there is a need to find a more suitable conductive particle 131 for replacement.

As illustrated in FIGS. 3 to 4, an embodiment of the present application discloses a conductive particle 131. The conductive particle 131 includes a core 132 and a conductive layer 133. The conductive layer 133 is formed on the surface of the core 132. The material of the core 132 is polystyrene, and the material of the conductive layer 133 is polyaniline. In this application, the core 132 is used to maintain the shape of the conductive particle 131 and can also play a supporting role. The polystyrene (PS) material is selected as the core 132 of the conductive particle 131 because the polystyrene material is elastic, and the particle size of the polystyrene core 132 is controllable, and the elasticity of the polystyrene core 132 is also adjustable, so that the above parameters can be adjusted depending on different cell gaps to meet a variety of needs. As such, when the polystyrene core 132 touches the circuit wires, it will change its shape and will not be squeeze the circuit wires to chase a short circuit. As illustrated in FIG. 3, which is a schematic diagram of a polystyrene core 132 observed with a scanning electron microscope. The conductive layer 133 is coated on the polystyrene core 132 to make the conductive particle 131 have a conductive property. As for not setting the conductive material as a whole solid spherical shape, it is because the cost of conductive materials is relatively expensive. If only one layer of conductive film is used, less materials are used, which can reduce the cost of the entire conductive particle 131. In addition, the conductive materials are generally metal, so that making the conductive layer 133 into a solid spherical shape will increase the weight of the conductive particle 131 which may easily sink in the sealant 130, thus affecting the connection effect.

As illustrated in FIG. 4, which is a schematic diagram of a polystyrene core 132 combined with a polyaniline conductive layer 133 observed with a scanning electron microscope. The conductive layer 133 in this application uses polyaniline (PANI) material, because polyaniline material has the characteristics of low density, good conductivity, good chemical stability, low price, and unique physical and chemical properties. It is widely used in many fields, and has become one of the most popular organic conductive materials. Its electrical conductivity has reached the order of 102 S/cm, which can make the conductive effect of the conductive particle 131 reach a very good point. Compared with metal conductive materials, polyaniline materials are lower in price and lighter in weight, can make the conductive particles 131 more uniformly distributed in the sealant 130, and can further reduce the manufacturing cost of the panel.

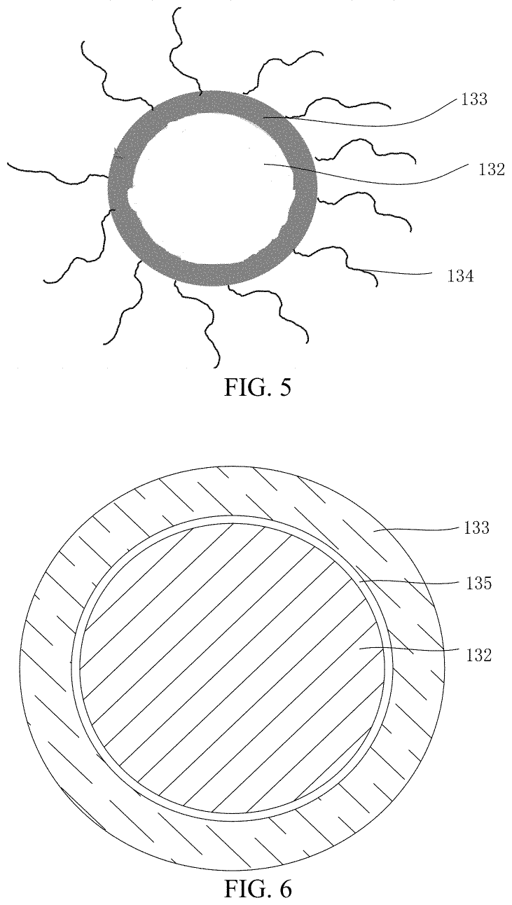

As illustrated in FIG. 5, which shows a schematic diagram of another conductive particle 131 according to this application. In addition to the above-mentioned core 132 made of polystyrene material and the conductive layer 133 made of polyaniline material coated on the outer surface of the core 132, the conductive particle 131 may further include a hydrophobic layer 134 that is made of hydrophobic material and that is disposed on the outer surface of the conductive layer 133. In this application, a hydrophobic layer 134 is attached to the outside of the polyaniline conductive layer 133. The hydrophobic layer 134 is made of hydrophobic materials or even superhydrophobic materials, including materials such as polytetrafluoroethylene, heptafluoroacrylate, polyacrylonitrile, and silane coupling agent. The hydrophobic material has a waterproof effect and can prevent water vapor from penetrating into the display, so it can reduce the probability of formation of bubbles and increase the service life of the product.

In addition, as illustrated in FIG. 6, the conductive particle 131 further includes an adhesion layer 135, which is disposed between the core 132 and the conductive layer 133. The adhesion force between the adhesion layer 135 and the conductive layer 133 is greater than the adhesion force between the core 132 and the conductive layer 133. The role of the adhesion layer 135 is to increase the adhesion between the core 132 and the conductive layer 133, and prevent gas from entering between the core 132 and the conductive layer 133 during the formation of the conductive layer 133 because the adhesion between the core 132 and the conductive layer 133 is two weak, which may otherwise affect the performance of the conductive particles. In addition, if the adhesion between the core 132 and the conductive layer 133 is too small, the conductive layer 133 cannot be easily formed or coated on the surface of the core 132. The adhesion layer 135 can be formed by reacting concentrated sulfuric acid with polystyrene; it can also be a rough surface created on the surface of the polystyrene core 132 to increase the adhesion with the conductive layer, as long as the adhesion between the polystyrene core 132 and the polyaniline conductive layer 133 can be increased, and so the method will not be limited herein.

It should be noted that the conductive particle 131 according to the present application can only be composed of two structures: a core 132 made of polystyrene and a conductive layer 133 made of polyaniline. The conductive particle 131 may also be composed of three structures: a core 132 made of polystyrene, a conductive layer 133 made of polyaniline, and a hydrophobic layer 134 made of a hydrophobic material. The conductive particle 131 may also be composed of three structures: a core 132 made of polystyrene, a conductive layer 133 made of polyaniline, and an adhesion layer 135. Of course, the conductive particle 131 may also be composed of four structures: a core 132 made of polystyrene, a conductive layer 133 made of polyaniline, a hydrophobic layer 134 made of a hydrophobic material, and an adhesion layer 135.

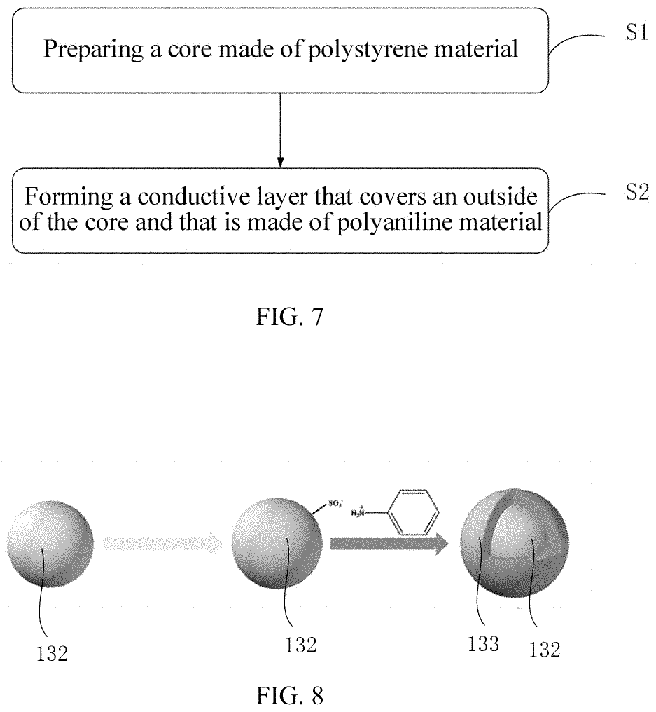

As illustrated in FIG. 7, as another embodiment of the present application, a method for preparing a conductive particle 131 is disclosed, which includes the following operations:

S1: preparing a core made of polystyrene material;

S2: forming a conductive layer covering on the outside of the core and made of polyaniline material.

In addition, the method may further include the following operation subsequent to the operation S2:

S3: forming a hydrophobic layer made of a hydrophobic material on the outer surface of the conductive layer.

The function of step S3 is to make the conductive particle 131 achieve a hydrophobic effect. All the conductive particles 131 in the sealant 130 can be regarded as a waterproof structure of the display panel 100, which prevents water vapor from entering the inside of the screen thus playing a good protective effect. The method of forming a hydrophobic layer composed of a hydrophobic material or even a super-hydrophobic material on the outer surface of the polyaniline conductive layer 133 may include grafting. The specific method may include placing the composite material of polyaniline and polystyrene in an aqueous solution containing the hydrophobic material and at a temperature of 90° C. and reflux for 2-6 hours. The hydrophobic material may be polytetrafluoroethylene, heptafluoroacrylate, polyacrylonitrile, silane coupling agent, etc.

Furthermore, the method may further include the following operation between S1 and S2:

S4: modifying the core to form an adhesion layer on the surface of the core;

The adhesion force between the adhesion layer and the conductive layer is greater than the adhesion force between the core and the conductive layer.

The use of polystyrene and polyaniline (PS@PANI) organic composite materials for the conductive balls has lower cost and good compatibility with the material of the sealant 130. In addition, the polystyrene core 132 has a controllable particle size and adjustable elasticity, which can meet the needs of different liquid crystal cell thicknesses. The operation of modifying the polystyrene core 132 is to increase the adhesion of the polystyrene core 132 and prevent the polyaniline conductive layer 133 from falling off during the process of attaching the polystyrene core 132 to the polystyrene core 132. Referring now to FIG. 8, which shows a schematic diagram illustrating the manufacturing process of the conductive particle 131, including the operations of modifying the polystyrene core 132 and coating the polyaniline conductive layer 133 on the polystyrene ball. From FIG. 8, the state changes of the conductive particle 131 at different stages can be observed very intuitively.

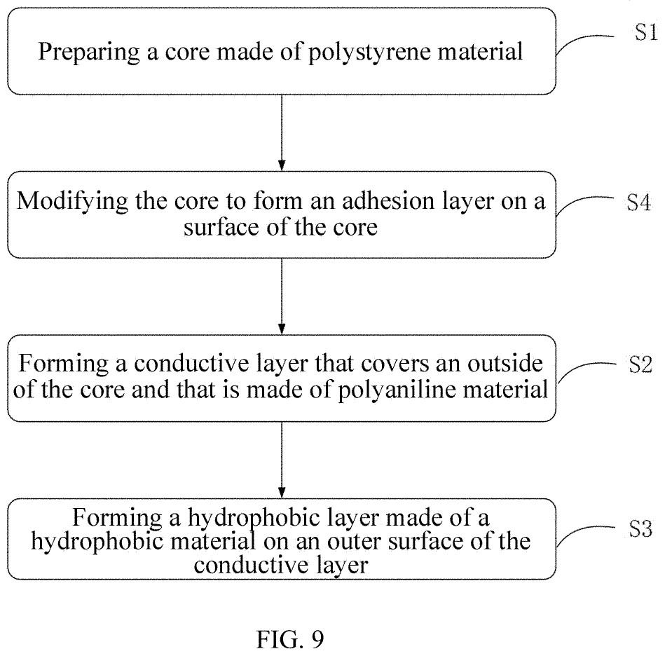

The conductive particle in this application can be prepared in two steps, S1 and S2, or in three steps, S1, S4, and S2. Of course, steps S1, S4, S2, and S3 can also be used, namely the method of preparing a conductive particle as illustrated in FIG. 9:

S1: preparing a core made of polystyrene material;

S4: modifying the core to form an adhesion layer on the surface of the core;

S2: forming a conductive layer covering on the outside of the core and made of polyaniline;

S3: forming a hydrophobic layer made of a hydrophobic material on the outer surface of the conductive layer.

Regarding the method for preparing the core 132, this embodiment also provides specific operations, where S1 further includes the following operations:

S11: adding polyvinylpyrrolidone and absolute ethanol into a container, and stirring to form a homogeneous system;

S12: blowing nitrogen gas into the container;

S13: dropping a monomer in which azobisisobutyronitrile is dissolved into the container;

S14: blowing nitrogen gas into the container and stirring the liquid in the container to polymerize the liquid in the container to produce a polymer emulsion;

S15: centrifuging the polymer emulsion to obtain a first sediment; and

S16: washing and drying the first sediment and to obtain a core made of polystyrene material.

The container in step S11 may use a four-necked bottle, because of the need to stir the materials in the container, vent and exhaust gases, as well as the fact that the condenser tube may also be used. Therefore, the use of four-necked bottle can not only reduce the procedures of changing the container, but also make it possible to carry out multiple operations at the same time without interfering with each other, which greatly improves the production efficiency. In addition, in S11, the volume ratio of polyvinyl pyrrolidone (PVP) and absolute ethanol may be 1:1, and the two are stirred into a homogeneous system, which is a single phase, that is to say, stir the two substances in the container into a liquid mixture. In S12, the effect of continuously injecting nitrogen gas into the container is to empty the oxygen in the container to avoid other reactions. In S13, it is recommended that the monomer in which azobisisobutyronitrile is dissolved be added dropwise to the container at a slow speed to avoid a safety hazard caused by an overly strong reaction.

In addition, in S14, the liquid in the container is subjected to polymerization reaction at 70±3° C. for 24 hours. Adjusting the polymerization reaction time to a longer time can make the liquid polymerization reaction in the container more thorough. In step S15, the polymer emulsion is centrifuged using an ultracentrifuge. The ultracentrifuge can not only adjust the centrifugal speed, but can also control the centrifugal speed to a larger one, so that the formation speed of the first sediment is accelerated, and the production efficiency is improved. In step S16, an ethanol solution is used to wash the first sediment. Because the original polymer emulsion contains residual ethanol, when the ethanol is used to wash the first sediment, the ethanol will not react with the first sediment. In addition, ethanol is easy to volatilize and easy to handle. In order to prevent the incomplete washing of the first sediment causing impurities in the finally produced polystyrene core 132, ethanol can be used repeatedly for washing. The drying temperature can be 60±3° C., at which the residual ethanol can quickly evaporate. The reason for not setting the temperature too high is to reduce energy loss and reduce costs.

Regarding the method of modifying the polystyrene core 132, this embodiment also provides specific operations, namely S4 includes the following operations:

S41: adding the core to concentrated sulfuric acid and stirring it evenly;

S42: centrifuging the concentrated sulfuric acid mixed with the core to obtain a second sediment; and

S43: washing and drying the second sediment to obtain a core with an adhesion layer on the surface.

The above modification of the polystyrene core 132 can also be said to be a sulfonation treatment of polystyrene. The purpose is to increase the adhesion of the polyaniline conductive layer 133 on the surface of the polystyrene core 132 and prevent the polyaniline material from falling off during the formation of the polyaniline material on the polystyrene core 132. In S41, the inventor found that adding the polystyrene core 132 to the concentrated sulfuric acid with a concentration of 20% to 40%, and placing the concentrated sulfuric acid solution mixed with the polystyrene core 132 50±3° C. and stirring it for 8 hours can more quickly achieve the desired effect. In S42, the mixed liquid can also be centrifuged with an ultracentrifuge.

Regarding the method of coating the polyaniline conductive layer 133 on the polystyrene core 132, this embodiment also provides specific operations, namely S2 may further include the following operations:

S21: dispersing the cores into a solution containing aniline monomer;

S22: using an acidic solvent as a dopant and ammonium persulfate as an oxidizing agent, and using an in-situ polymerization method to form a conductive layer that covers the core and that is made of polyaniline material.

It should be noted that the polystyrene core 132 in S21 may be unmodified, that is, after the polystyrene core 132 is made, the operation of attaching the polyaniline conductive layer 133 on the surface of the polystyrene core 132 is directly carried out. The polystyrene core 132 in S21 may also be the polystyrene core 132 modified in S4, and accordingly the specific operations corresponding to S2 may include:

S23: dispersing the core containing the adhesion layer on the surface into the solution containing the aniline monomer;

S24: using an acidic solvent as a dopant and ammonium persulfate as an oxidizing agent, and using an in-situ polymerization method to form a conductive layer made of polyaniline material on the surface of the adhesion layer.

That is, after the polystyrene core 132 is prepared, the polystyrene core 132 is modified in S4, and finally, the polyaniline conductive layer 133 is attached to the surface of the modified polystyrene core 132. In S22 and S24, the acidic solvent in the dopant may be hydrochloric acid, perchloric acid, sulfuric acid, or an organic acid. In addition, the in-situ polymerization method in S22 and S24 means to allow the aniline monomer to grow on the surface of the polystyrene core 132.

After S2, an organic composite conductive particle 131 composed of polyaniline and polystyrene (PS@PANI) would be obtained, more specifically, a conductive layer 133 made of polyaniline covering the core made of polystyrene 132. The PS@PANI conductive particle 131 created at this stage can already play the same role as the conductive gold ball, that is, to electrically connect the two substrates in the display panel 100, so that the conductive particle 131 can be directly used for production. Furthermore, the PS@PANI conductive particle 131 has a lower cost, good stability, good conductive effect, and smaller mass compared with conductive gold balls, so it can achieve good effects. Furthermore, the present application further attaches a hydrophobic layer 134 outside the polyaniline conductive layer 133, that is, step S3. The hydrophobic layer 134 is made of a hydrophobic material or a super-hydrophobic material. The function of this step is to prevent external water vapor from entering the display screen through the sealant 130, which may otherwise produce bubbles thereby affecting the screen display effect. As for the method of attaching the hydrophobic layer 134 to the polyaniline conductive layer 133, the effect can be achieved in the form of grafting.

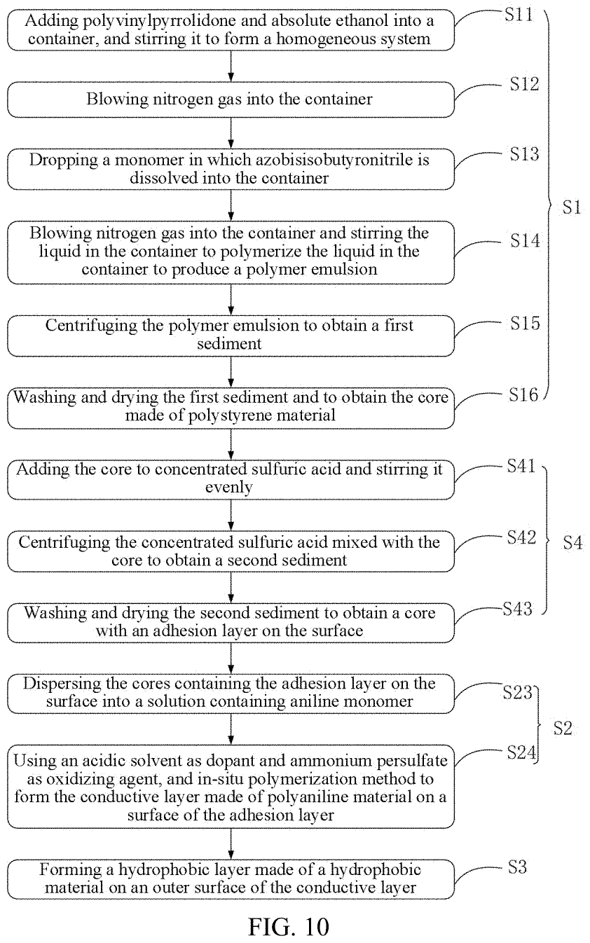

As illustrated in FIG. 10, as another embodiment of the present application, a method for preparing a conductive particle 131 is disclosed, which includes the following operations:

S11: adding polyvinylpyrrolidone and absolute ethanol into a container, and stirring to form a homogeneous system;

S12: blowing nitrogen gas into the container;

S13: dropping a monomer in which azobisisobutyronitrile is dissolved into the container;

S14: blowing nitrogen gas into the container and stilling the liquid in the container to polymerize the liquid in the container to produce a polymer emulsion;

S15: centrifuging the polymer emulsion to obtain a first sediment; and

S16: washing and drying the first sediment and to obtain a core made of polystyrene material;

S41: adding the core to concentrated sulfuric acid and stirring it evenly;

S42: centrifuging the concentrated sulfuric acid mixed with the core to obtain a second sediment; and

S43: washing and drying the second sediment to obtain a core with an adhesion layer on the;

S23: dispersing the cores containing the adhesion layer on the surface into a solution containing aniline monomer;

S24: using an acidic solvent as a dopant and ammonium persulfate as an oxidizing agent, and using an in-situ polymerization method to form a conductive layer made of polyaniline material on the surface of the adhesion layer;

S3: forming a hydrophobic layer made of a hydrophobic material on the outer surface of the conductive layer.

After all the manufacturing processes are completed, the finally formed conductive particles 131 need to be tested. The testing method includes the use of a scanning electron microscope and a transmission electron microscope for morphological characterization. In particular, the composite material sample of the prepared conductive particles 131 is pressed into a sheet, and both ends are coated with conductive silver adhesive to test the conductivity. When the test finds no problems, the conductive particles 131 can be added to the sealant 130 and put into production and application.

It should be noted that the limitations of various operations involved in this solution will not be deemed to limit the order of the operations, provided that they do not affect the implementation of the specific solution, so that the operations written earlier may be executed earlier or they may also be executed later or even at the same time. As long as the solution can be implemented, they should all be regarded as falling in the scope of protection of this application.

The technical solution of this application can be widely used in various display panels, such as Twisted Nematic (TN) display panels, In-Plane Switching (IPS) display panels, and Vertical Alignment (VA) display panels, and Multi-Domain Vertical Alignment (MVA) display panels. Of course, other types of display panels, such as organic light-emitting diode (OLED) display panels are also applicable to the above solutions.

The foregoing description is merely a further detailed description of the present application made with reference to some specific illustrative embodiments, and the specific implementations of the present application will not be construed to be limited to these illustrative embodiments. For those having ordinary skill in the technical field to which this application pertains, numerous simple deductions or substitutions may be made without departing from the concept of this application, which shall all be regarded as falling in the scope of protection of this application.

What is claimed is:

1. A conductive particle, comprising:
a core; and
a conductive layer, covering the core;
wherein the core is made of polystyrene, and the conductive layer is made of polyaniline.

2. The conductive particle as recited in claim 1, further comprising a hydrophobic layer arranged on an outer surface of the conductive layer, wherein the hydrophobic layer is made of a hydrophobic material.

3. The conductive particle as recited in claim 2, wherein the hydrophobic material comprises polytetrafluoroethylene, heptafluoroacrylate, polyacrylonitrile, or silane coupling agent.

4. The conductive particle as recited in claim 1, further comprising an adhesion layer arranged between the core and the conductive layer, and wherein an adhesion force between the adhesion layer and the conductive layer is greater than an adhesion force between the core and the conductive layer.

5. The conductive particle as recited in claim 4, wherein the adhesion layer is formed by reacting concentrated sulfuric acid with polystyrene.

6. The conductive particle as recited in claim 4, wherein the adhesion layer is formed by a rough surface created on a surface of the core.

7. The conductive particle as recited in claim 1, further comprising an adhesion layer and a hydrophobic layer, wherein the adhesion layer is arranged between the core and the conductive layer, and an adhesion force between the adhesion layer and the conductive layer is greater than an adhesion force between the core and the conductive layer, and wherein the hydrophobic layer is arranged on an outer surface of the conductive layer, and the hydrophobic layer is made of a hydrophobic material.

8. A method for preparing a conductive particle, comprising:
preparing a core made of polystyrene material; and
forming a conductive layer that covers an outside of the core and that is made of polyaniline material.

9. The method as recited in claim 8, further comprising the following operation subsequent to the operation of forming the conductive layer that covers the outside of the core and that is made of polyaniline material:
forming a hydrophobic layer made of a hydrophobic material on an outer surface of the conductive layer.

10. The method as recited in claim 9, wherein the hydrophobic layer is formed by refluxing the composite material of polyaniline and polystyrene in an aqueous solution containing a hydrophobic material at a temperature of 90° C. for 2-6 hours.

11. The method as recited in claim 8, further comprising an operation of modifying the core to form an adhesion layer on a surface of the core, subsequent to the operation of preparing the core made of polystyrene material;
wherein an adhesion force between the adhesion layer and the conductive layer is greater than an adhesion force between the core and the conductive layer.

12. The method as recited in claim 8, wherein the operation of preparing the core made of polystyrene material comprises:
adding polyvinylpyrrolidone and absolute ethanol into a container, and stirring to form a homogeneous system;
blowing nitrogen gas into the container;
dropping a monomer in which azobisisobutyronitrile is dissolved into the container;
blowing nitrogen gas into the container and stirring the liquid in the container to polymerize the liquid in the container to produce a polymer emulsion;
centrifuging the polymer emulsion to obtain a first sediment; and
washing and drying the first sediment and to obtain the core made of polystyrene material;

13. The method as recited in claim 12, wherein the container comprises a four-necked bottle.

14. The method as recited in claim 12, wherein a volume ratio of the polyvinylpyrrolidone and the absolute ethanol is 1:1.

15. The method as recited in claim 8, wherein the operation of forming the conductive layer that covers the outside of the core and that is made of polyaniline material comprises:
dispersing the cores into a solution containing aniline monomer; and
using an acidic solvent as a dopant and ammonium persulfate as an oxidizing agent, and using an in-situ polymerization method to form the conductive layer that covers the outside of the core and that is made of polyaniline material.

16. The method as recited in claim 15, wherein the dopant comprises perchloric acid, sulfuric acid, or an organic acid.

17. The method as recited in claim 8, wherein the operation of forming the conductive layer that covers the outside of the core and that is made of polyaniline material comprises:
dispersing the cores containing the adhesion layer on the surface into a solution containing aniline monomer; and
using an acidic solvent as a dopant and ammonium persulfate as an oxidizing agent, and using an in-situ polymerization method to form the conductive layer made of polyaniline material on a surface of the adhesion layer.

18. The method as recited in claim 17, wherein the dopant comprises perchloric acid, sulfuric acid, or an organic acid.

19. The method as recited in claim 11, wherein the operation of modifying the core to form the adhesion layer on the surface of the core comprises:
adding the core to concentrated sulfuric acid and stirring it evenly;
centrifuging the concentrated sulfuric acid mixed with the core to obtain a second sediment; and
washing and drying the second sediment to obtain a core with an adhesion layer on the surface;

20. A display panel, comprising:
a first substrate;
a second substrate, arranged opposite to the first substrate; and
a conductive particle, filled between the first substrate and the second substrate, wherein the conductive particle comprises a core and a conductive layer covering the core, wherein the core is made of polystyrene, and the conductive layer is made of polyaniline;
wherein the first substrate is electrically connected to the second substrate through the conductive particle.
